(19) United States
(12) Patent Application Publication
(10) Pub. No.: US 2007/0295573 A1
(43) Pub. Date: Dec. 27, 2007

(54) VIBRATION DAMPER AND/OR TORQUE TRANSFER DEVICE AND METHOD OF ASSEMBLY

(75) Inventors: Connard Cali, Dublin, CA (US); Carlos Ferreira, Santa Catarina (BR)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: CONNTECHNICAL INDUSTRIES, INC., DUBLIN, CA (US)

(21) Appl. No.: 11/425,433

(22) Filed: Jun. 21, 2006

(51) Int. Cl. F16D 41/12

(52) U.S. Cl. 192/46

(57) ABSTRACT

Embodiments of a vibration damper and/or torque transfer device and a method for assembly thereof are provided herein. In one embodiment, a vibration damper and/or torque transfer device includes a pocket plate having a first surface and an opposing second surface. The pocket plate further has a recess formed therein on the first surface and a throughbore extending from a bottom surface of the recess to the second surface of the pocket plate. A strut is disposed in the recess and a cap is aligned with the throughbore proximate the second surface of the pocket plate. A resilient member is disposed within the throughbore between a bottom surface of the strut and the floor plate.

### BACKGROUND OF THE INVENTION

1. Field of the Invention

The present invention generally relates to vibration dampers and torque transfer devices and methods for assembly thereof.

2. Description of the Related Art

Automotive clutches, particularly alternator clutches, are known in the art as means for engaging and disengaging gears, providing controlled rotation speeds throughout a particular gear system. While a wide variety of clutch assemblies exist, the general differences between the known embodiments relate to the efficiency of the clutch in engaging and disengaging gears. However, regardless of the efficiency of the method or means utilized by the clutch to engage or disengage neighboring gears, one major problem remains largely unresolved.

Many conventional alternator clutches utilize struts disposed in a pocket plate to interface with an adjacent portion of the clutch and provide for the transfer of rotational motion in a given direction. For example, FIG. 4 depict a partial, exploded side view of one conventional clutch assembly 400 having upwardly biased struts 402 disposed in a pocket plate 404 that interfaces with an interior notch plate 406 of a pulley 408. The struts 402 are placed in a recess 410 formed in the pocket plate 404 and are upwardly biased to a position extending beyond the surface of the pocket plate by springs 412. The springs 412 are disposed in holes 414 formed in the pocket plate 404 below the struts 402. During assembly, the strut spring 412 is first placed in the hole 414. A top portion 416 of the spring 412 extends beyond the surface of the pocket plate 404. The strut 402 is then placed in the recess 410 of the pocket plate 404. A bottom surface of the strut 402 rests on the top of the spring 412, thereby biasing the strut 402 at an upward angle.

The placement of the spring and subsequent placement of the strut is a very difficult process to perform reliably, as the struts easily fall to the side or tip the spring out of place. If struts are not correctly placed and aligned with the spring, the assembly may fail. Furthermore, even if the springs and struts are initially balanced properly on the pocket plate, the pocket plate, spring, and strut sub-assembly must then be moved and placed against a mating notch plate located inside a pulley body of the clutch. This process is performed “blind,” (e.g., the assembler cannot see the springs and struts due to the pulley body). As such, the blind assembly process often results in misalignment of the springs or struts, thereby requiring the assembly process to be repeated or resulting in a defective clutch assembly which may fail prematurely.

Therefore, a need exists for a clutch and method of assembly that overcomes the problems present in the prior art.

### SUMMARY OF THE INVENTION

Embodiments of a vibration damper and/or torque transfer device and a method for assembly thereof are provided herein. In one embodiment, a vibration damper and/or torque transfer device includes a pocket plate having a first surface and an opposing second surface. The pocket plate further has a recess formed therein on the first surface and a throughbore extending from a bottom surface of the recess to the second surface of the pocket plate. A strut is disposed in the recess and a cap is aligned with the throughbore proximate the second surface of the pocket plate. A spring is disposed within the throughbore between a bottom surface of the strut and the floor plate.

In another aspect of the invention, a method for assembly of a vibration damper and/or torque transfer device is provided herein. In one embodiment, a method of assembling a vibration damper and/or torque transfer device includes placing a strut into a recess formed in a first surface of a pocket plate; contacting the first surface of the pocket plate with a notch plate; inserting a resilient member into a throughbore that extends from an opposing second surface of the pocket plate to the recess in the first surface of the pocket plate; and placing a cap against the second surface of the pocket plate to seal the throughbore. The cap may comprise a notch plate. The cap and/or notch plate may further be disposed within a pulley body.

### BRIEF DESCRIPTION OF THE DRAWINGS

So the manner in which the above recited features of the present invention can be understood in detail, a more particular description of the invention, briefly summarized above, may be had by reference to the embodiments thereof, some of which are illustrated in the appended drawings. It is to be noted, however, the appended drawings illustrate only typical embodiments of this invention and are therefore not to be considered limiting of its scope, for the invention may admit to other equally effective embodiments.

FIG. 1 depicts an exploded, cross-sectional view of one embodiment of the automotive clutch assembly of the present invention.

FIG. 2 depicts a top elevation view of one embodiment of the pocket plate of the present invention.

FIG. 3 depicts a flow chart of one method of assembly of one embodiment of the present invention.

FIG. 4 depicts a partial, exploded side view of a conventional clutch assembly.

To facilitate understanding, identical reference numerals have been used, where possible, to designate identical elements that are common to the figures.

### DETAILED DESCRIPTION

The present invention generally provides for vibration dampers and/or torque transfer devices and methods for assembly thereof that overcome the problems of the prior art described above. In one embodiment, the vibration damper and/or torque transfer device may be an alternator clutch. It is contemplated that the benefits afforded by the clutch and method of assembly disclosed herein may be utilized in diverse applications, such as, but not limited to, vehicular, stationary, marine, or industrial (for example, torque converters, automatic transmissions, starter drives, starter motors, compressors, accessory drives, and the like). As such, the illustrative description of the invention described in the embodiments below are not to be construed as limiting of the scope of the invention with respect to its application.

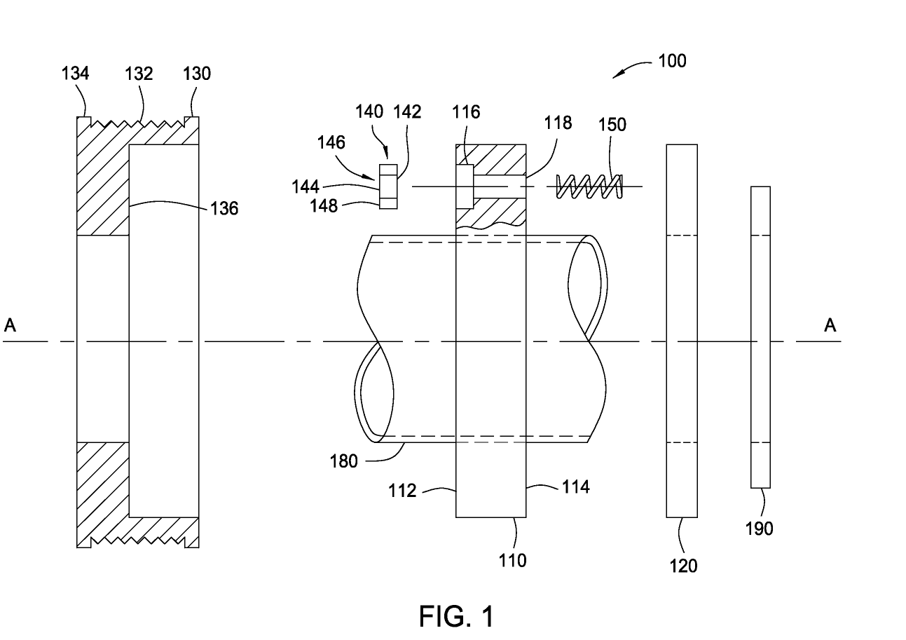

FIG. 1 depicts an exploded, cross-sectional view of one embodiment of a clutch 100 of the present invention. The clutch 100 generally includes a pocket plate 110, a floor plate 120, and a notch plate 134. The notch plate 134 may optionally be disposed within a pulley body 130 (as depicted in FIG. 1). The pocket plate 110, floor plate 120, and notch plate 134 of the clutch 100 are typically disposed and aligned on a shaft 180 to selectively transmit rotational motion to the assembly, for example, from a belt (not shown) driving the pulley body 130 to some other component, such as an alternator (not shown) connected to the shaft 180.

The pocket plate 110 has a first surface 110 and an opposing second surface 114. At least one recess 116 is formed in the first surface 112 of the pocket plate 110. The recess 116 is generally shaped to receive and support a strut 140 placed therein. A throughbore 118, aligned with each recess 116, is formed in the pocket plate 110 to create a passage connecting the first surface 112 of the pocket plate 110 to the second surface 114.

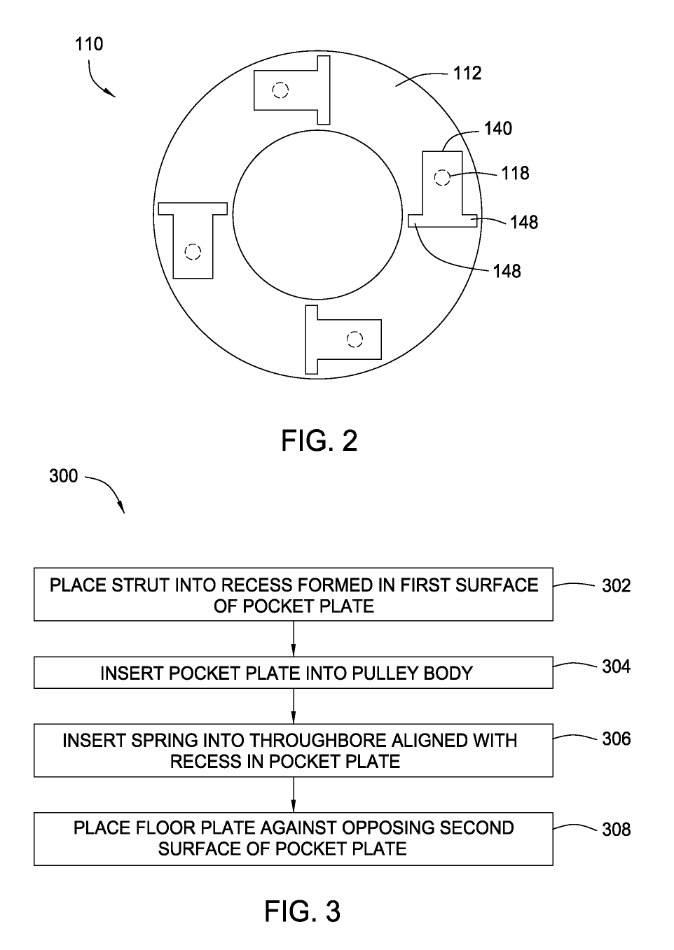

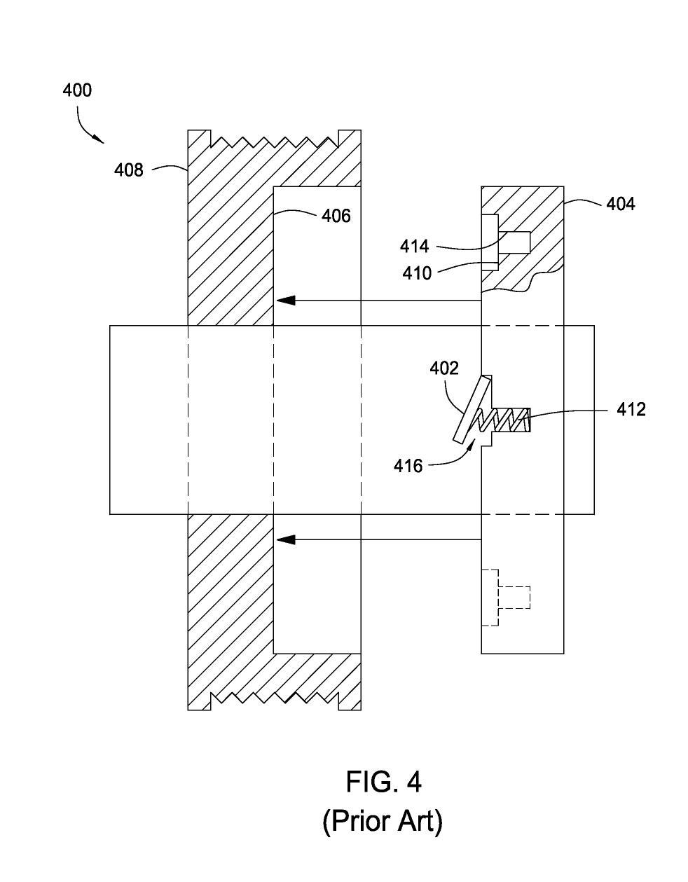

The strut 140 is typically shaped to fit within the recess 116 and may have a feature formed thereon to facilitate maintaining alignment of the strut 140 within the recess 116. For example, in the embodiment depicted in FIG. 1, a protrusion 148 is formed at one end of the strut 140. As seen in FIG. 2A, protrusions 148 may be formed on both sides of the strut 140 to form a “T,” thereby providing additional stability. Returning to FIG. 1, the strut 140 further has a bottom surface 142 facing the bottom of the recess 116 in the pocket plate 112 and an opposing upper surface 144. An edge 146 of the upper surface 144, typically opposite the protrusions 148, is configured to interface with a notch plate 136 of the pulley body 130 when the clutch 100 is assembled.

A resilient member 150 is disposed within the throughbore 118. The resilient member 150 is typically a compression spring and may have any form or shape suitable to outwardly bias the strut 140 when the clutch 100 is assembled. As used herein, the term “outwardly bias” refers to a bias of the edge 146 of the strut 140 towards the notch plate 136. In one embodiment, the resilient member 150 is a helical coil compression spring of sufficient length to outwardly bias the strut 140. The spring constant and spring length may be selected to control the force of the outward bias of the strut 140 during operation of the clutch 100. The resilient member 150 may be any suitable resilient member having the characteristics described above, such as but not limited to, coil springs, thermosets, engineering resins, elbow springs, torsion springs, flex washers, and the like.

It is contemplated that any practical number of struts and corresponding recesses, throughbores, and springs, may be provided in the automotive clutch of the present invention. For example, in one embodiment of the automotive clutch 100, depicted in FIGS. 2A and 2B, four struts 140 and resilient members 150 are provided. Accordingly, four corresponding recesses 116 and throughbores 118 are formed in the pocket plate 110. The struts 140 may be equally spaced radially about a central axis of the pocket plate 100.

Returning to FIG. 1, the pulley body 130 typically includes an outer surface 132 that interfaces with a drive belt (not shown). The outer surface 132 may include features that mate with corresponding features of the belt, for example, v-grooves, square grooves, and the like. Additionally, the outer surface 132 may include a lip, rib, or other protrusion 134 to maintain alignment of the belt on the pulley body 130. The pulley body also includes an internal notch plate 134 that interfaces with the struts 140 disposed within the pocket plate 110. The notch plate 134 contains a series of notches, or grooves (not shown) formed radially about the notch plate 134. The notches provide a solid interface for the edges 146 of the struts 140 to engage during rotational movement of the clutch in a predefined direction.

The floor plate 120 is disposed against the pocket plate 110 opposite the pulley body 130. The floor plate 120 covers the throughbores 118 in the pocket plate 110, thereby retaining the springs 150 therein. The floor plate 120 may be coupled to pocket plate 110, the shaft 180 or a combination. The floor plate 120 may be held in place by any suitable means, including but not limited to a press fit onto the shaft 180, use of set screws, snap rings, or other fasteners, being welded, glued, or otherwise bonded to either the pocket plate 110 or the shaft 180, or the like. The floor plate can be a stand-alone plate, as shown in FIG. 1, or may be part of another assembly having a floor built into it.

Optionally, a locking mechanism 190 may be utilized to secure the floor plate 120 to the shaft 180. The locking mechanism 190 may be a lock collar or ring, a clamp, a press-fit bearing, or any other suitable locking device known in the art.

FIG. 3 depicts one embodiment of a method of assembling the clutch 100. The method begins at step 302, where struts 140 are inserted into recesses 116 located on the first surface 112 of the pocket plate 110. As discussed above, the clutch 100 may have one or more struts 140 and corresponding recesses 116. Next, at step 304, the pocket plate 110 and struts 140 are inserted into the pulley body 130. The pocket plate 110 is typically inserted until the first surface 112 of the pocket plate 112 and the struts 140 are disposed against the notch plate 136. The struts 140 are relatively light and often small. Thus, in conventional applications, the struts are typically difficult to place, prone to movement, sensitive to assembly vibrations, and easily offset from their original placement. Here, the struts 140 advantageously lie flat within the recess 116 of the pocket plate 110 during step 304, thereby minimizing the risk of strut misalignment within the recess 116.

Next, at step 306, resilient members 150 are inserted into the throughbores 118 of the pocket plate 110. As discussed above, each throughbore 118 lines up beneath a corresponding recess 116 and, therefore, strut 140. In this manner, the top portion of each of the resilient members 150 lie flat against the bottom surface 142 of the struts 140, thereby advantageously reducing or eliminating the risk of spring misalignment with the struts and providing for even compression distribution among all the spring coils during operation.

At step 308, the floor plate 120 is placed against the second surface 114 of the pocket plate 110. Positioning the floor plate 120 compresses the resilient members 150 between the bottom surface 142 of the strut 140 and the floor plate 120. As discussed above, compressing the resilient members 150 after the struts 140 and pocket plate 110 are positioned against the notch plate 136 advantageously allows for ease of assembly while minimizing the risk of strut and/or spring misalignment. Optionally, step 308 may include providing a locking mechanism 190 to secure the floor plate 120 in place.

Thus, a vibration damper and/or torque transfer device and assembly process are provided herein having improved reliability and reduction in potential field failures due to the reduction or elimination of strut and/or spring misalignment that may occur in conventional clutches. The sequence of steps described above with respect to FIG. 3 are illustrative for one embodiment. It is contemplated that other embodiments may involve different steps which still leverage upon the advantages offered by the present invention as described above without departing from the scope of the invention.

While the foregoing is directed to illustrative embodiments of the present invention, other and further embodiments of the invention may be devised without departing from the basic scope thereof.

What is claimed is:

1. A vibration damper and/or torque transfer device, comprising:
a pocket plate having a first surface and an opposing second surface, the pocket plate further having a recess formed therein on the first surface and a throughbore extending from a bottom surface of the recess to the second surface of the pocket plate;
a strut disposed in the recess;
a cap aligned with the throughbore proximate the second surface of the pocket plate; and
a resilient member disposed within the throughbore between a bottom surface of the strut and the floor plate.

2. The device of claim 1, wherein the cap comprises:
a floor plate abutting the second surface of the pocket plate.

3. The device of claim 2, further comprising:
a locking mechanism securing the floor plate adjacent the second surface of the pocket plate.

4. The device of claim 1, wherein the device is a component of one of an alternator clutch, a torque converter, an automatic transmission, a starter drive, a starter motor, a compressor, or an accessory drive.

5. The device of claim 1, further comprising a notch plate disposed adjacent the first surface of the pocket plate.

6. The device of claim 5, wherein the notch plate is contained within a pulley body.

7. The device of claim 1, wherein the resilient member is a helical coil compression spring.

8. The device of claim 1, wherein the resilient member is at least one of a coil spring, a thermoset, an engineering resin, an elbow spring, a torsion spring, and a flex washer.

9. The device of claim 1, further comprising a plurality of throughbores, recesses, struts, and resilient members as described in claim 1.

10. The device of claim 9, further comprising four throughbores, recesses, struts, and resilient members as described in claim 1.

11. The device of claim 9, wherein the struts are substantially equidistantly spaced radially from one another with respect to a central axis of the pocket plate.

12. The device of claim 1, further comprising:
a shaft centrally disposed through the pocket plate.

13. The device of claim 1, further comprising:
a plurality of throughbores, recesses, struts, and resilient members as described in claim 1; and
a notch plate contained within a pulley body and disposed adjacent the first surface of the pulley body.

14. The device of claim 12, further comprising:
a shaft centrally disposed through the pocket plate and pulley body.

15. A method of assembling a vibration damper and/or torque transfer device, comprising:
placing a strut into a recess formed in a first surface of a pocket plate;
contacting the first surface of the pocket plate with a notch plate;
inserting a resilient member into a throughbore that extends from an opposing second surface of the pocket plate to the recess in the first surface of the pocket plate; and
placing a cap against the second surface of the pocket plate to seal the throughbore.

16. The method of claim 15, wherein the cap comprises a floor plate.

17. The method of claim 16, further comprising:
securing the floor plate in place adjacent the second surface of the pocket plate.

18. The method of claim 15, wherein the device is a component of one of an alternator clutch, a torque converter, an automatic transmission, a starter drive, a starter motor, a compressor, or an accessory drive.

19. The method of claim 15, wherein the resilient member is a helical coil compression spring.

20. The method of claim 15, wherein the resilient member is at least one of a coil spring, a thermoset, an engineering resin, an elbow spring, a torsion spring, and a flex washer.

21. The method of claim 15, wherein the pocket plate is disposed on a shaft.

22. The method of claim 15, wherein the step of contacting the first surface of the pocket plate with a notch plate further comprises:
inserting the pocket plate at least partially into a pulley body having the notch plate disposed therein.
